(19) United States
(12) Patent Application Publication
(10) Pub. No.: US 2007/0150326 A1
(43) Pub. Date: Jun. 28, 2007

(54) Information apparatus

(75) Inventors: Muneki Nakao, Kanagawa-ken (JP); Taketomo Naruse, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/576,533

(22) PCT Filed: Oct. 19, 2004
(86) PCT No.: PCT/JP04/15771

§ 371 Date: Apr. 20, 2006

(30) Foreign Application Priority Data
Oct. 21, 2003 (JP) 2003-361290
Jun. 11, 2004 (JP) 2004-174196

(51) Int. Cl. G05B 19/418

(52) U.S. Cl. 705/8

(57) ABSTRACT

In an information apparatus having a scheduler function of notifying a user of a predetermined “schedule” as a reminder on a notice “scheduled” date, that function is structured to prevent carelessly sending old reminders, or many unintentional reminders. In this apparatus, a reminder notification is validated only for “schedules” for which reminders are to be sent within a predetermined time before the current date, and reminders are sent only for these “schedules”.

### TECHNICAL FIELD

The present invention relates to a reminder notification function such as an alarm, a display, or a function of transmitting by mail a “schedule” input associated with a communication function in an information apparatus, as means for providing a user with a notification of the input “schedule” in a schedule management function such as a calendar function in the information apparatus.

### BACKGROUND ART

Conventionally, there has been a telephone set having a schedule management function (see Japanese Patent Application Laid-Open No. 2000-253109, for example).

In recent years, information apparatuses have had a schedule management function in association with a calendar function, and some apparatuses comprise a reminder notification function such as an alarm or a function of transmitting by mail a “schedule” input associated with a communication function in the information apparatus as means for providing a user with a notification of the input “schedule”.

Further, there has been known a method of providing a user with a notification of a “schedule” that had been erased due to power interruption (see Japanese Patent Application Laid-Open No. H09-275540, for example).

However, when there are present a plurality of unnotified input “schedules” in the conventional information apparatus and the notice dates of the several “schedules” have lapsed, a reminder is sent for each of the several “schedules”.

In other words, when a user incorrectly sets a future date as the current date in the information apparatus, all the input future “schedules” before the set date are sent to the user. Thus, when 100 “schedules” for the next year are input, for example, if the user incorrectly sets the date one year later than it should be, the reminder is sent for each of the 100 “schedules”.

When the notice method of these “schedules” is mail, since mails are sequentially transmitted after the user incorrectly sets the date, there is a problem that a large amount of “schedules” may be sent to the outside, unlike the notice method such as generating an alarm, which causes an irrecoverable situation.

In the conventional techniques, the following problem is assumed. Though when the information apparatus is powered OFF on the date of the input “schedule”, no reminder is sent during power-OFF, if the “schedule” is not lost during power-OFF, then when the power supply is powered ON or when a schedule application is started, the reminder of the “schedule” whose date has come during power-OFF in the information apparatus is sent.

In other words, when a period of the power-OFF in the information apparatus is long and many “schedules” are booked during power-OFF in the information apparatus, many reminders are sent on powering ON of the information apparatus. Thus, many old reminders which are now meaningless as scheduling are sent, and when the reminders are sent by mail, there is a problem that the old “schedules” are transmitted at once to the outside.

### SUMMARY OF THE INVENTION

It is an object of the present invention to provide an information apparatus capable of preventing careless sending of old reminders or of many unintentional reminders in the information apparatus which has a scheduler function of providing a predetermined “schedule” as a reminder on a notice “scheduled” date.

According to the present invention, since reminders of some unnotified “schedules” before the date set in the information apparatus are invalidated, and only valid reminders are sent, there is an effect that old reminders are not inadvertently sent, and the problem of emitting unintentional reminders is averted.

### BRIEF DESCRIPTION OF THE DRAWINGS

FIG. 1 is a structure diagram showing an information apparatus IA1 according to a first embodiment of the present invention;

FIG. 2 is a block diagram showing a specific structure of a display unit 105 used in the embodiment of FIG. 1;

FIG. 3 is a memory map showing an inner structure of a DRAM 103 used in the embodiment of FIG. 1;

FIGS. 4A, 4B and 4C are memory maps showing an inner structure of a non-volatile RAM 102 used in the embodiment of FIG. 1;

FIG. 5 is structure diagram showing an appearance of an operation unit 106 used in the embodiment of FIG. 1;

FIG. 6 is a diagram showing a “schedule” booking screen 601 which is one example of a screen on which a “schedule” is booked when using a scheduler function in the embodiment of FIG. 1;

FIG. 7 is a diagram showing one example of a reminder to be displayed on the display unit 105 when a user has input a “schedule” of which the user wishes to be notified and the notice date has now arrived;

FIG. 8 is a diagram showing one example of a reminder notification mail in transmitting a mail to the outside and sending a reminder to an outside mail terminal when the user has input a “schedule” to be sent and the notice date has now arrived;

FIG. 9 is a flowchart showing processes in which after the start of the scheduler function a “schedule” is input and then the scheduler function is completed in the information apparatus IA1;

FIG. 10 is a model diagram showing in time series whether “schedules” are sent as reminders in a relationship between a current date D registered in the information apparatus IA1 and a plurality of input “schedules”;

FIG. 11 is a model diagram showing in time series whether to provide a reminder with regard to a plurality of input “schedules” in relation with the current date D registered in the information apparatus IA1;

FIG. 12 is a flowchart showing an operation of making a decision for reminder notification by the information apparatus IA1;

FIG. 13 is a flowchart showing processes in which after the start of the scheduler function a “schedule” in input and then the scheduler function is completed, in an information apparatus 10 according to the first embodiment;

FIG. 14 is a model diagram showing in time series whether “schedules” are reminder-notified in a relationship between the current date D registered in the information apparatus 10 and a plurality of input schedules;

FIG. 15 is a model diagram showing in time series whether “schedules” are reminder-notified in a relationship between the current date D registered in the information apparatus 10 and a plurality of input schedules; and

FIG. 16 is a flowchart showing algorithm for determining whether the information apparatus 10 notifies a reminder in the first embodiment.

### BEST MODE FOR CARRYING OUT THE INVENTION

The best mode for carrying out the invention is the following embodiments.

### First Embodiment

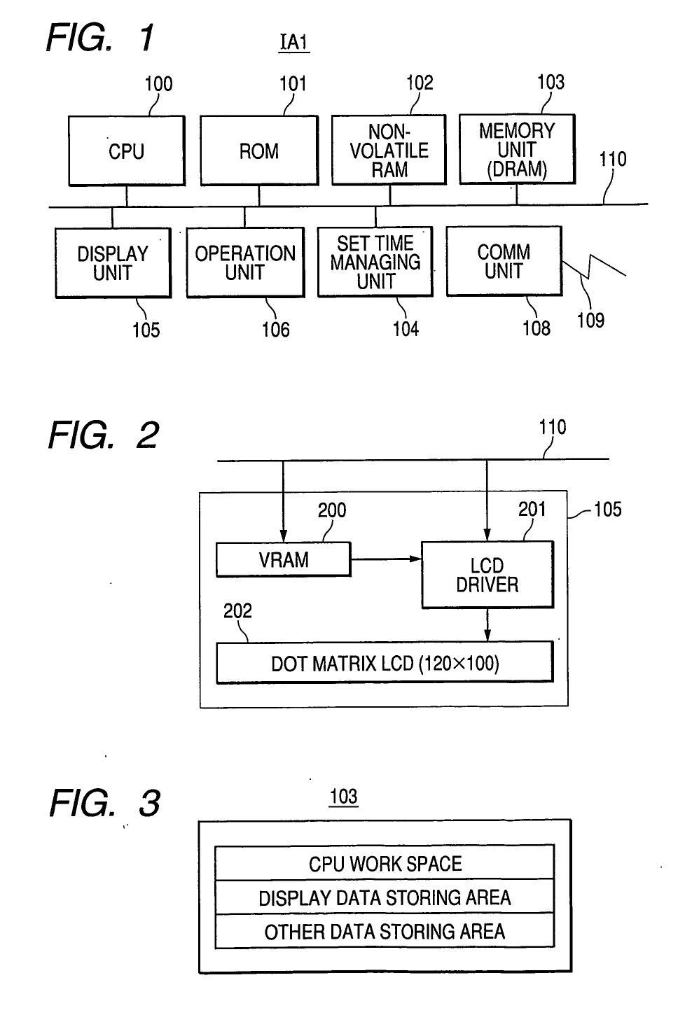

FIG. 1 is a structure diagram showing an information apparatus IA1 according to a first embodiment of the present invention.

The information apparatus IA1 is an information apparatus having a reminder-function-mounted electronic calendar, and has a CPU 100, a ROM 101, a non-volatile RAM 102, a memory unit (DRAM) 103, a set time managing unit 104, a display unit 105, an operation unit 106, a communication unit 108, and a system bus 110.

The CPU 100 controls the entire information apparatus. The ROM 101 is a memory storing therein a program and data. The non-volatile RAM 102 stores therein data for backing up user-booked “schedules” in a scheduler, personal data, address book, and the like.

The memory unit (DRAM) 103 stores therein CPU work data, display data, and the like. The set time managing unit 104 manages a current date, monitors a notice date of a “schedule” in the scheduler, and the like. The display unit 105 displays in colors an input screen of the scheduler, a reminder notification, a status of the apparatus, and the like.

The operation unit 106 has a numeric keypad (or ten-key) and the like. The communication unit 108 is connected to a line 109, and has a modem for communicating to the outside and the like. The respective processors 100 to 109 are connected with each other via the system bus 110.

FIG. 2 is a block diagram showing a specific structure of the display unit 105 used in the embodiment of FIG. 1.

The display unit 105 has a VRAM 200 storing therein display data, and a LCD driver 201 for outputting the contents of the VRAM 200 to a dot matrix LCD 202.

FIG. 3 is a memory map showing an inner structure of the DRAM 103 used in the embodiment of FIG. 1.

The DRAM 103 has a CPU work area, a display data storing area for storing therein data to be displayed on the display unit 105, and another data storing area for storing therein other data used by the CPU100, respectively.

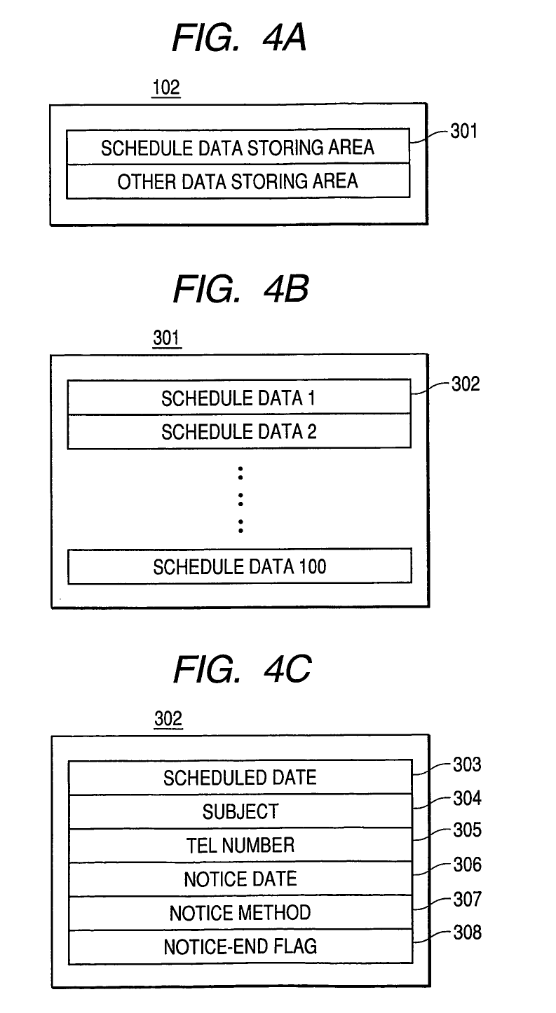

FIGS. 4A to 4C are memory maps showing an inner structure of the non-volatile RAM 102 used in the embodiment of FIG. 1.

The non-volatile RAM 102 has a “schedule” data storing area 301 and another data storing area storing therein other data as shown in FIG. 4A.

The “schedule” data storing area 301 stores therein 100 schedulers of “schedule” data 1 to “schedule” data 100 as shown in FIG. 4B.

The “schedule” data 302 has a “scheduled” date 303, a subject 304 indicating a “schedule” name, a telephone number 305, a notice date 306, a notice method 307, and a notice-end flag 308 as shown in FIG. 4C.

The “scheduled” date 303 indicates date/time of “schedule”. The telephone number 305 is a “schedule” for identifying a telephone number associated with the “schedule”. The notice date 306 is date/time when the “schedule” is to be sent to the user as a reminder. The notice method 307 is a “schedule” for designating a type of how to send a particular reminder. The notice-end flag 308 is set on FALSE when the “schedule” reminder has not been sent yet and is set on TRUE when the “schedule” reminder has been already sent.

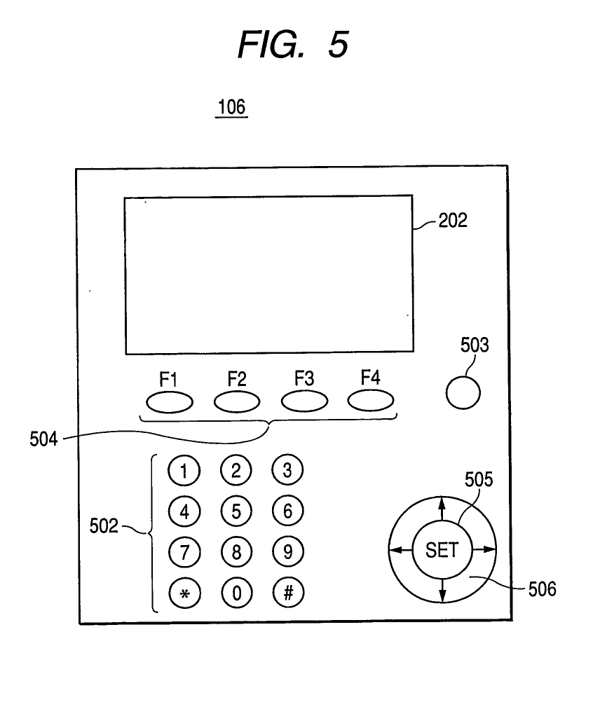

FIG. 5 is a structure diagram showing an appearance of the operation unit 106 used in the embodiment of FIG. 1.

The operation unit 106 has the LCD 202, a numeric keypad 502 for inputting a telephone number and the like, a booking key (or registration key) 503 used for function setting or the like, four function keys 504 used for multiple inputting, a set key 505 which is a setting input key, and a directional key 506 used for moving a cursor on the display unit.

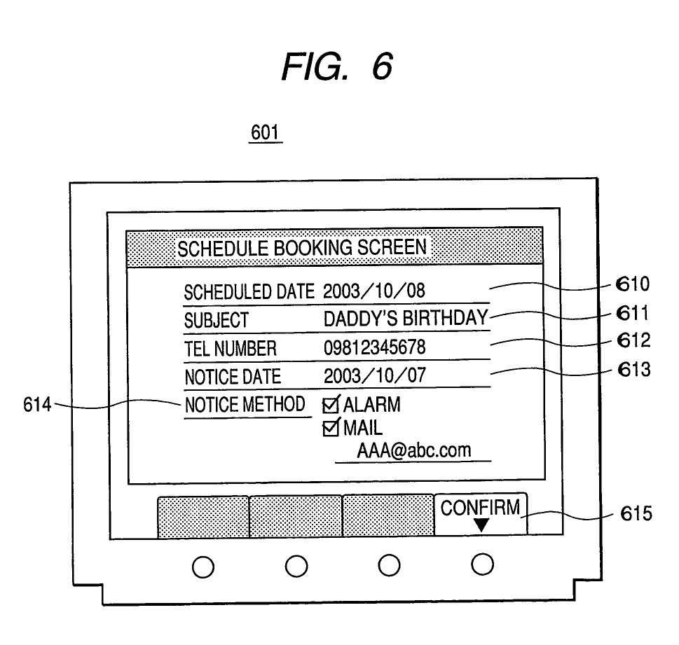

FIG. 6 is a diagram showing a “schedule” booking screen 601 which is one example of a screen for booking or registering a “schedule” when using the scheduler function in the embodiment of FIG. 1.

The “schedule” booking screen 601 has a “scheduled” date input column 610, a subject input column 611, a telephone number input column 612, a notice date input column 613, a notice method input column 614, and a booking button column 615.

The “scheduled” date input column 610 is an input column where a “scheduled” date of the user-“scheduled” “schedule” is input. The subject input column 611 is an input column where the subject of the user-“scheduled” “schedule” is input. The telephone number input column 612 is an input column where a contact telephone number associated with the “schedule” can be input. The notice date input column 613 is an input column where a notice date of the user-“scheduled” “schedule” is input. The notice method input column 614 is an input column where a method of sending a notification of the “schedule” as a reminder is designated. The booking button column 615 is an electronic button for confirming the booking.

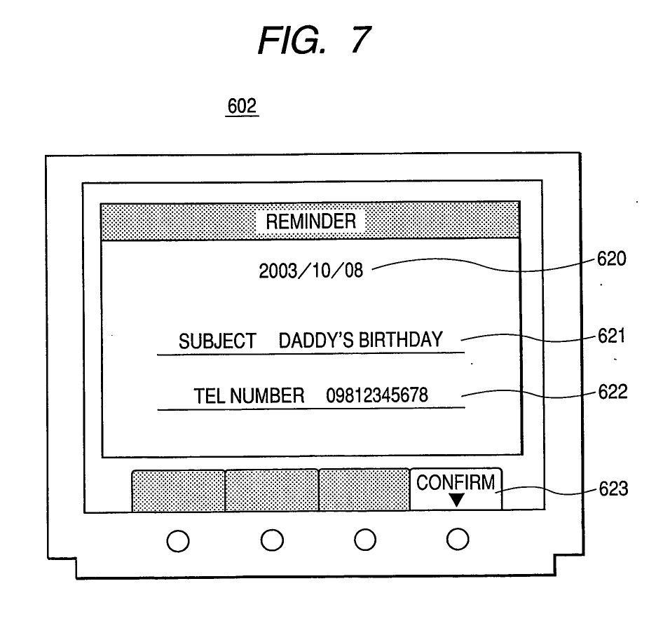

FIG. 7 is a diagram showing one example of a reminder displayed on the display unit 105 when the user has input a “schedule” of which the user wishes to be notified and the notice date has now come.

The reminder 602 is used to notify the user of the “schedule” on the screen of the information apparatus.

The reminder 602 has a “scheduled” date display column 620 indicating a “scheduled” date, a subject display column 621 indicating a “schedule” name, a telephone number display column 622 indicating an associated telephone number, and a confirmation button 623, which is an electronic button used for stopping the reminder display after the notified “schedule” is confirmed.

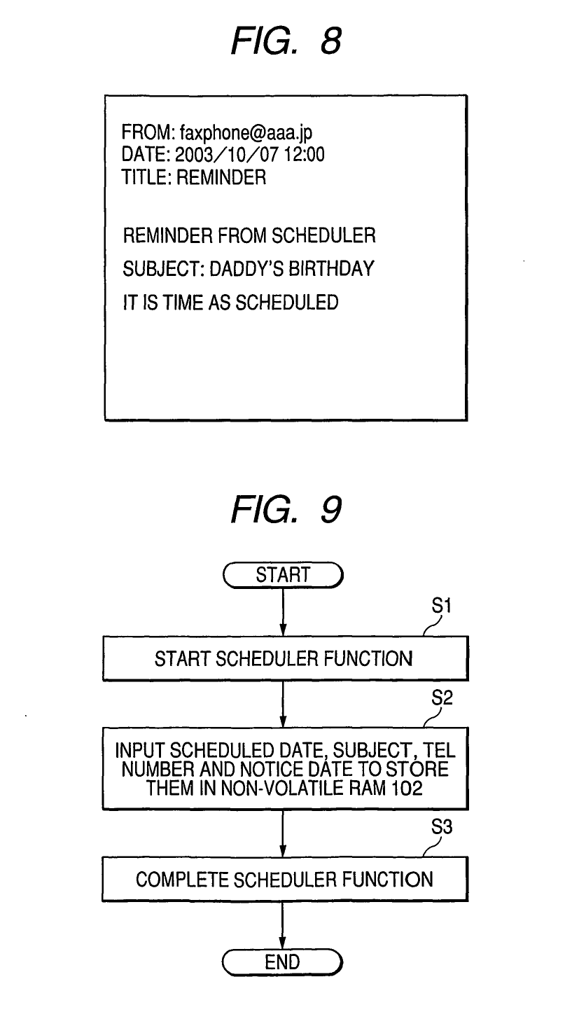

FIG. 8 is a diagram showing one example of a reminder notification mail for transmitting a mail to the outside and providing a reminder to an outside mail terminal when the user has input a “schedule” of which a reminder is to be provided, and the notice date has now arrived.

The notice mail refers to the contents of the “schedule” data in the “schedule” data storing area 301 and transmits a mail when the “scheduled” transmission date comes. When the contents are referred to, the reminder notification is valid only for the “schedules” reminders of which are provided within a predetermined time from a date set in the information apparatus IA1 back to the past before the date set in the information apparatus IA1 specific to the embodiment. In the reminder notification, a mail is transmitted when the notice method is set as transmission by mail in the user setting shown in FIG. 7.

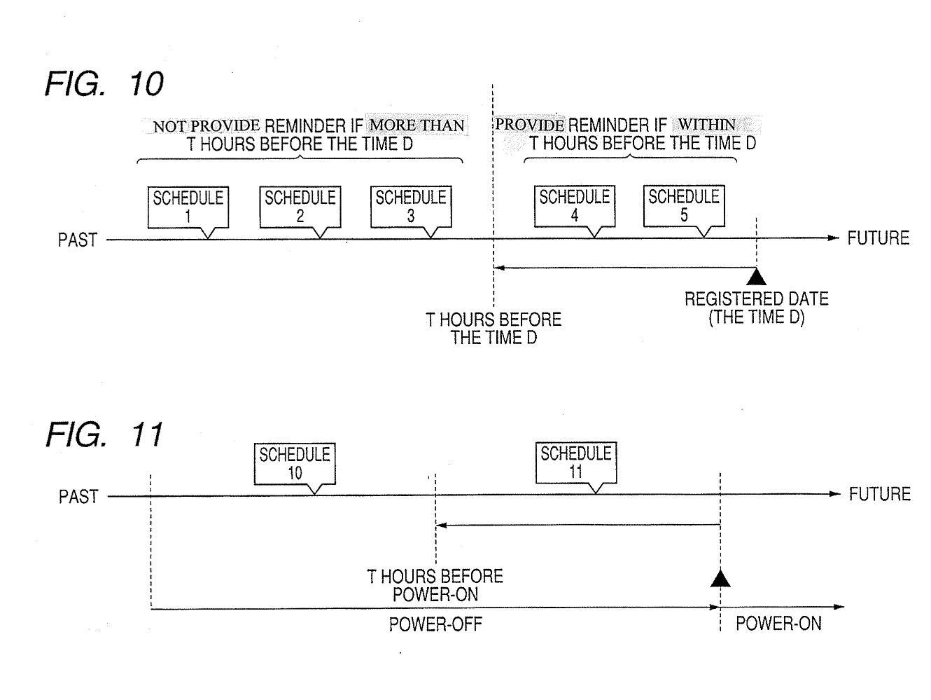

FIG. 9 is a flowchart showing processes in which after the start of the scheduler function a “schedule” is input and then the scheduler function is completed, in the information apparatus IA1.

First, the scheduler function is started in step S1 and the processing proceeds to step S2. In step S2 the user uses the “schedule” booking screen 601 to input the date of “schedule”, the subject, the telephone number, the notice date, and the notice method, and the processing proceeds to step S3.

In step S3 the user presses the booking button 615 to confirm the input “schedule” and to store the data in the non-volatile RAM 102, and completes the processing shown in FIG. 9.

FIG. 10 is a model diagram showing in time series whether “schedules” are reminder-notified in a relationship between the current date D registered in the information apparatus IA1 and a plurality of input “schedules”.

The time line in FIG. 10 indicates the past to the left and the future to the right, and a plurality of “schedules” are input on the time line. In FIG. 10, though one predetermined “schedule” is set on one predetermined date, a plurality of “schedules” may be double-booked on one date.

In FIG. 10, a “schedule” with regard to which a reminder is to be sent by a time not earlier than T hours before the current date D registered in the information apparatus, is validated, and a corresponding reminder is sent. As for such a “reminder-notified” “schedule”, that is, one for which a reminder is to be sent and the time of which is not more than T hours before the present, the notice-end flag 308 is made “ON” in the “schedule” data 302 shown in FIGS. 4A to 4C, and one item of “schedule” data is set for provision of a reminder to the user.

A “schedule” which has passed beyond the predetermined time (T hours) on the time line is invalidated, and no reminder will be sent with regard to this “schedule”. As for the “schedule” which is not “reminder-notified:, the notice-end flag 308 of the “schedule” data is made “ON”.

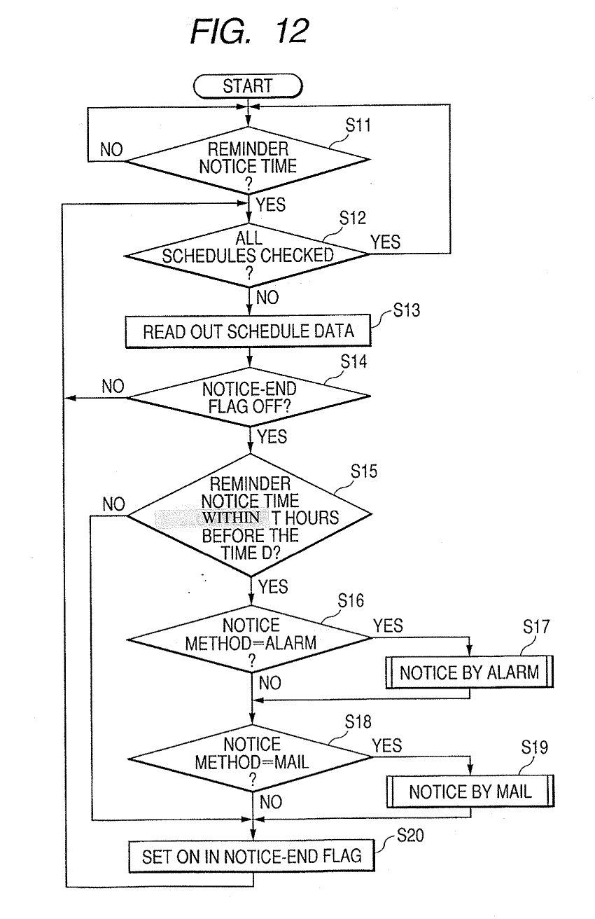

In the flowchart in FIG. 12 described later, in step S20, where the notice-end flag 308 is made “ON”, the characteristics of the embodiment are described, but this notice-end flag 308 may remain “OFF” instead of particularly being made “ON”, so that the “schedule” may remain without a reminder being sent.

In this case, when the current date registered in the information apparatus IA1 is incorrect, the error is later discovered, and the incorrect current date is reset to the correct date, the “schedule” as to which no reminder has been sent, remains, but the above problem does not occur.

FIG. 11 is a model diagram showing in time series whether or not a reminder should be sent for a plurality of input “schedules” in relation to the current date D registered in the information apparatus IA1 similarly to the above.

In other words, FIG. 11 is a model diagram for determining whether the “schedule” is to be “reminder-supported” (i.e., to be brought to the user's attention by means of a reminder) when the information apparatus IA1 is powered ON at a predetermined time after the power-OFF period.

Though the booked “schedule” is not reminder-supported on the time line while the information apparatus IA1 is in power-OFF, the “schedule” to be reminder-supported within the predetermined time (T hours) back to the past before the date of the power-ON when the power supply is powered ON, is validated and is reminder-notified similarly as shown in FIG. 10.

As for the reminder-supported “schedule”, the notice-end flag 308 is set “ON” in the “schedule” data 302 shown in FIGS. 4A to 4C so that one “schedule” is made notified.

Similarly, the “schedule” which was to have been reminder-supported in the past before T hours is invalidated, and no reminder is provided with regard to that “schedule”. As for the “schedule” which is not reminder-supported, the notice-end flag 308 of the “schedule” data is made ON.

Also, here, similarly as in the above, the notice-end flag 308 may remain OFF instead of particularly being made ON.

FIG. 12 is a flowchart showing an operation of determining for reminder notification by the information apparatus IA1.

When the information apparatus IA1 is powered ON, the operation is started, and in S11 whether the time to provide a reminder has come, is determined, at a constant cycle. In S12 it is determined whether all the schedules for which reminders are to be notified are checked in the “schedule” data. When it is determined in S12 that a “schedule” to be checked is present, in S13 the next “schedule” data is read out from the non-volatile RAM, and in S14 whether the notice-end flag 308 is OFF is determined in the “schedule” data.

When the notice-end flag 308 is ON, the processing returns to the loop and proceeds to S12. When the notice-end flag 308 is OFF, which means that no reminder has been provided with regard to the “schedule”, the processing proceeds to S15, where it is determined whether the reminder notice date is within the predetermined time (T hours) before the current time registered in the information apparatus IA1.

When the date is determined to be within the predetermined time, it is determined that the “schedule” is to be reminder-supported, and the processing proceeds to S16. In S16 when the notice method of the “schedule” is determined to be “alarm”, in S17 the reminder is provided by alarm. In this case, the reminder is given on the screen, as well.

Next, in S18 when the notice method of the “schedule” is determined to be “mail”, the processing proceeds to S19, where a reminder about the “schedule” is provided by mail. (The method of transmitting the “schedule” in the non-volatile RAM by mail is well known, and thus detailed description thereof is not repeated.) The destination of the mail is one stored as a mail address in the notice method 307 in the “schedule” data shown in FIGS. 4A to 4C.

When the reminder notification of the “schedule” is completed by alarm or mail, then in S20 the notice-end flag indicating that the notification about the “schedule” is completed, is made ON.

When the processing proceeds to S20, because the reminder notice date was more than T hours in the past as determined in S15, the notice-end flag 308 may remain OFF instead of particularly being made ON so that the “schedule” may remain unsupported by a reminder.

In this case, when the current date registered in the information apparatus IA1 is incorrect, the error is later discovered, and the current date is reset to the correct current date, a “schedule” as to which no reminder has yet been given, remains reminder-supported, and a still more-preferable operation can be achieved.

The relative arrangement of the constituents, the display screen, and the like according to the embodiment may employ a relative arrangement other than that illustrated and described herein, and a display screen other than the display screen according to the embodiment as described may be used, unless particularly stated otherwise.

In other words, the embodiment is an example of an information apparatus which has a scheduler function of notifying a user of a predetermined “schedule” as a reminder on a notice “scheduled” date, comprising a control unit which provides a reminder of an unnotified “schedule” when the time indicated for the reminder is not more than a predetermined time in the past, but does not provide a reminder as to an unnotified “schedule” If the indicated reminder time is more than the predetermined time in the past.

The present embodiment is an example of an information apparatus comprising a control unit which, when a notice “scheduled” date arrives while the apparatus is in the power-OFF status and then the apparatus is powered ON, notifies a “schedule” as to which no reminder has been given, and as to which the indicated notice time is not more than a predetermined time in the past before the current time, then a reminder is given, while no reminder is given for such a “schedule” if the indicated notice time is more than the predetermined time in the past.

Further, the embodiment can be grasped as the invention of a program. In other words, the embodiment is an example of a program which controls an information apparatus having a scheduler function of providing a notice of a predetermined “schedule” as a reminder on a notice “scheduled” date, which causes a computer to execute a notification procedure of providing a reminder of a “schedule” as to which no reminder has been given, but only if the indicated notice date is not more than a predetermined time in the past, and what may be termed an “unnotification” procedure, of not providing a reminder of a “schedule” as to which a reminder has not yet been given, where the indicated reminder or notice time is more than the predetermined time in the past.

The embodiment is an example of a program which causes a computer to execute such notification and unnotification procedures, as described above.

### Second Embodiment

Next, a second embodiment will be described. Like numerals denote parts identical to those having the same reference numerals in the first embodiment, and thus description thereof is not repeated. FIG. 1 to FIG. 8 are similar to the first embodiment, and thus description thereof also is not repeated.

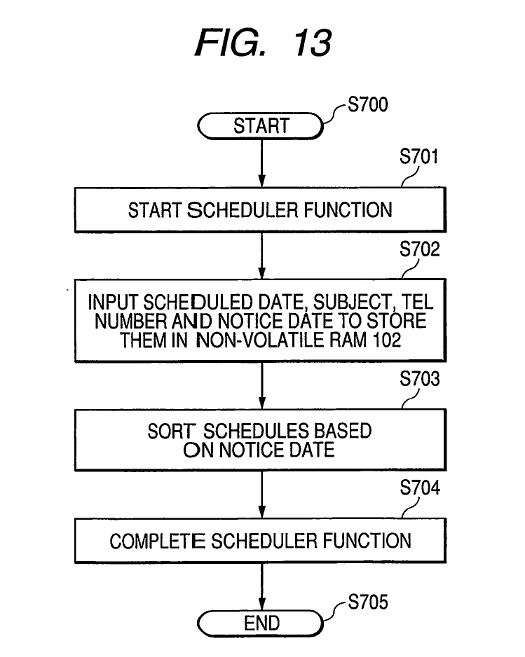

FIG. 13 is a flowchart showing processes in which after the start of the scheduler function a “schedule” is input, and then the scheduler function is completed, in the information apparatus 10 according to the first embodiment.

At first, in S701 the scheduler function is started, and in S702 the user uses the “schedule” booking screen 601 to input a “scheduled” date, subject, telephone number, notice date, and notice method.

In S703 the “schedule” data stored in the “schedule” data storing area 301 is sorted based on time, and the sorted “schedule” data is stored in the non-volatile RAM 102, in S704 the scheduler function is completed, and in S705 the processing shown in FIG. 13 is completed.

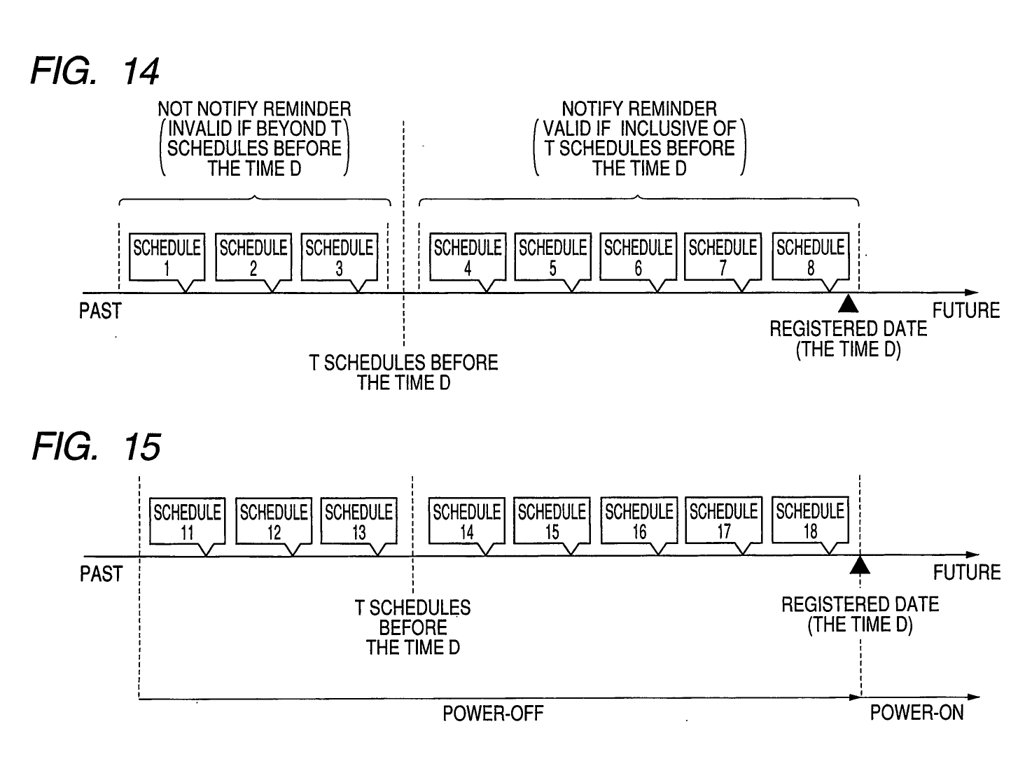

FIG. 14 is a model diagram showing in time series whether the “schedules” are reminder-supported in relationship between the current date (D) registered in the information apparatus 10 and a plurality of input “schedules”.

The time line indicates the past to the left and the future to the right, and a plurality of “schedules” are input on the time line. In FIG. 14, though one predetermined “schedule” is set on one predetermined date, a plurality of “schedules” may be double-booked on one date.

In FIG. 14, a “schedule” that is to be reminder-supported but as to which no reminder has been given, and which is included in a predetermined number of schedules (T schedules) in the past on the time line before the current date D registered in the information apparatus 10, is validated, and a reminder as to that “schedule” is given. As for the reminder-supported “schedule”, the notice-end flag in the “schedule” data 302 shown in FIGS. 4A to 4C is made ON, and the notification as to one item of “schedule” data is completed.

A “schedule” which was to be reminder-supported in the past, but before the T schedules on the time line, is invalidated and no reminder is provided as to that “schedule”. As for the “schedule” which is not reminder-supported, the notice-end flag in the “schedule” data is made ON.

The notice-end flag may remain OFF instead of being made ON, and the “schedule” may remain unsupported by a reminder. In this case, when the current date registered in the information apparatus is incorrect, the error is later discovered, and the current date is reset to the correct date, this “schedule” as to which no reminder has been made, is brought to the user's attention on an original notice date, and thus a still more-preferable operation can be achieved.

FIG. 15 is a model diagram showing in time series whether “schedules” are reminder-supported in a relationship between the current date D registered in the information apparatus and a plurality of input “schedules” similarly as in the above.

FIG. 15 is a model diagram for determining whether the “schedule” is reminder-supported when the information apparatus is powered ON at a predetermined time after the power-OFF period.

Though the booked “schedule” is not reminder-supported while the information apparatus is in power-OFF, the “schedule” to be reminder-supported which is included in a predetermined number of schedules (T schedules) in the past on the time line before the date of the power-ON, is validated and a reminder is provided as to that “schedule”, similarly to what is shown in FIG. 10 when the power supply is powered ON. As for the reminder-supported “schedule”, the notice-end flag in the “schedule” data 302 shown in FIG. 4C is made ON, and a reminder as to one item of “schedule” data is provided.

Similarly, the “schedule” which was to be reminder-supported in the past but before T schedules on the time line, is invalidated and no reminder is provided as to that “schedule”. As for such a “schedule” which is not, the notice-end flag in the “schedule” data is made ON. Also in this case, similarly to the above, the notice-end flag may remain OFF instead of being made ON.

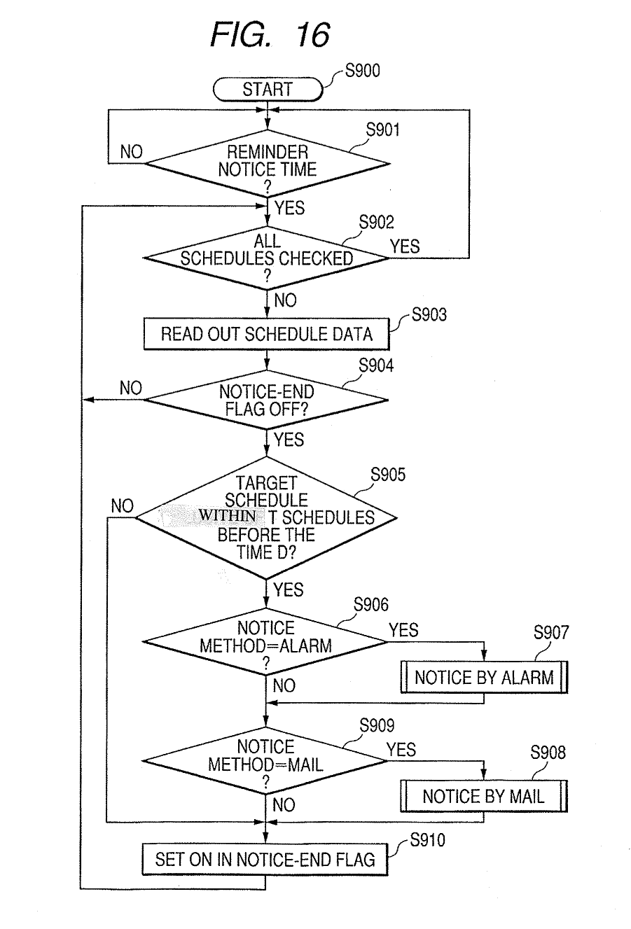

FIG. 16 is a flowchart showing an algorithm for determining whether the information apparatus 10 provides a reminder in the first embodiment.

When the information apparatus is powered ON, an operation of the algorithm is started, and in S901 whether a timing to provide a reminder ahs arrived, is determined, at a constant cycle. In S902 it is determined whether all the booked “schedules” are checked in the “schedule” data. When it is determined in S902 that a “schedule” yet to be checked is present, in S903 the next “schedule” data is read out from the non-volatile RAM, and in S904 whether the notice-end flag is OFF is determined in the “schedule” data.

When the notice-end flag is ON, the processing returns to the loop, and proceeds to S902. When the notice-end flag is OFF, which means that no reminder for the “schedule” has yet been provided, the processing proceeds to S905, where it is determined whether the “schedule” to be reminder-supported is included in T schedules before the current date registered in the information apparatus. When the “schedule” is determined to be included in T schedules, the “schedule” is determined to be reminder-supported, and in S906 when the notice method of the “schedule” is determined to be “alarm”, in S907 a reminder is provided, by alarm.

In this case, a reminder notification is displayed also on the screen, as shown in FIG. 7.

Next, when in S909 the notice method of the “schedule” is determined to be “mail”, in S908 a reminder about the “schedule” is provided by mail. The method of transmitting the “schedule” stored in the non-volatile RAM by-mail is well known, and thus detailed description thereof is not repeated.

FIG. 8 shows one example of a mail sent to the mail destination when the reminder is by mail. A destination of the mail is one stored as a mail address in the notice method 307 in the “schedule” data shown in FIG. 4C.

When the reminder notification of the “schedule” is completed by alarm or mail, in S910 the notice-end flag of the corresponding “schedule” data is made ON, and the “schedule” data is changed to the status where the notification about the “schedule” is completed.

Here, the notice-end flag may remain OFF instead of being made ON when the processing proceeds from S905 where the “schedule” data is not in the mentioned time period (where the notice date of the booked “schedule” is not included in T schedules before the current date in the information apparatus) to S910.

In this case, when the current date registered in the information apparatus is incorrect, the error is later discovered, and the current date is reset to the correct date, the “schedule” as to which no reminder has been given can nonetheless be reminder-supported, so that a still more-preferable operation can be achieved.

The present invention can be realized by incorporating the above functions in an application program such as a scheduler operating on a general computer. In this case, the present invention can be constituted as the above embodiments by detecting the transition between power-ON and power-OFF in the computer, and further the present invention can be realized by determining whether a “schedule” to be reminder-supported is present each time a scheduler application program is started, in order to apply to a case where the scheduler application program is started after a period when the scheduler application program is stopped even when the computer is in power-ON.

This application claims priority from Japanese Patent Applications Nos. 2003-361290, filed on Oct. 21, 2003, and 2004-174196, filed on Jun. 11, 2004, which are hereby incorporated by reference herein.

1. (canceled)

2. An information apparatus comprising a control unit which, when a notice “scheduled” date comes in a power-OFF status and then the apparatus is powered ON, provides a notification of “schedule” as to which a reminder has not yet been given and for which an indicated notice time is not more than a predetermined time in the past before a current date, as a reminder, and does not notify provide any reminder as to a “schedule” as to which an indicated notice time is more than the predetermined time in the past before the current date.

3. (canceled)

4. A method of controlling an information apparatus comprising the steps of:
when a notice “scheduled” date comes in a power-OFF status and then the power supply is powered ON, providing a notification of “schedule” as to which no reminder has yet been given, and as to which an indicated notice time is not more than a predetermined time before the notice “scheduled” date, as a reminder; and
when the notice “scheduled” date comes in the power-OFF status and then the power supply is powered ON, not providing a notification of “schedule” as to which an indicated notice time is more than the predetermined time before the notice “scheduled”.

5. (canceled)

6. A program which causes a computer to execute:
a notification procedure of, when a notice “scheduled” date comes in a power-OFF status and then the power supply is powered ON, providing a notification of “schedule” as to which no reminder has been provided, and as to which an indicated notice time is not more than a predetermined time in the past, as a reminder; and
an unnotification procedure of, when the notice “scheduled” date comes in the power-OFF status and then the power supply is powered ON, not providing a notification of the “schedule” as to which the indicated notice time is more than the predetermined time in the past.

7. (canceled)

8. An information apparatus which is directed for providing a notification of an unnotified schedule whose notice “scheduled” date registered in the apparatus comes while the apparatus is in a power-OFF status, wherein an unnotified schedule which is included in a set of a predetermined number of schedules that are most recent before a current date set in the information apparatus is communicated as a reminders when the apparatus is powered ON, and
an unnotified schedule which is not included in that set, is not communicated as a reminder.

9. (canceled)

10. A method of notifying a schedule as to which no reminder has been given due to stop of a communication function even when a notice “scheduled” date has arrived in the function of notifying user of a schedule booked in an information apparatus,
wherein when the notification function is started thereafter, schedule as to which no reminder has been given and which is included in a set of a predetermined number of schedules that are most recent before a current date set in the information apparatus, is communicated as a reminder, and
schedule which is not included in that set, is not communicated as a reminder.

11. A notice method according to claim 10, wherein a stop status of a notification function is a status where an information apparatus is powered OFF, and the notification function is started when the information apparatus is powered ON.

12. A program which causes a computer to execute notification of a booked schedule and is directed for providing a notification of a schedule as to which no reminder has been given due to stop of a notification function even when a notice “scheduled” date arrives, wherein when the notification function is started thereafter,
schedule as to which no reminder has been given and which is included in a set of a predetermined number of schedules most recent before a current date set in an information apparatus, is communicated as a reminder, and
schedule which is not included in that set, is not communicated as a reminder.

13. A program according to claim 12, wherein a stop status of a notification function is a status where an information apparatus is powered OFF, and the notification function is started when the information apparatus is powered ON.
